(19) United States
(12) Patent Application Publication
(10) Pub. No.: US 2025/0351240 A1
(43) Pub. Date: Nov. 13, 2025

(54) HEATING COOKER

(71) Applicant: SHARP KABUSHIKI KAISHA, Sakai City (JP)

(72) Inventors: Toshiyuki GOTO, Sakai City (JP); Nobuo TAKEMOTO, Sakai City (JP)

(21) Appl. No.: 19/190,425

(22) Filed: Apr. 25, 2025

(30) Foreign Application Priority Data
May 9, 2024 (JP) 2024-076450

(51) Int. Cl. H05B 6/64

(52) U.S. Cl. CPC H05B 6/642

(57) ABSTRACT

A heating cooker includes: a heating and cooking chamber configured to heat an object to be heated; a housing configured to accommodate the heating and cooking chamber; and an electric component arranged between the heating and cooking chamber and the housing, wherein the heating and cooking chamber has a vertical wall that intersects a horizontal direction, the housing has a vertical outer wall facing the vertical wall, the electric component includes a main body portion that is arranged between the vertical outer wall and the vertical wall, and a projecting portion that projects from the main body portion in a first direction from the vertical outer wall toward the vertical wall, and at least a part of the projecting portion is located further in the first direction than an end portion in a second direction opposite to the first direction of the heating and cooking chamber.

### CROSS-REFERENCE TO RELATED APPLICATION

The present application claims priority from Japanese Application JP2024-076450 the content to which is hereby incorporated by reference into this application.

### BACKGROUND OF THE INVENTION

### 1. Technical Field

The present disclosure relates to a heating cooker.

### 2. Description of the Related Art

A heating cooker disclosed in JP 2010-181112 A includes a magnetron that generates microwaves, a heating and cooking chamber, and a plurality of electric components. A plurality of the electric components include a cooling fan and a high-voltage transformer. A plurality of the electric components including a cooling fan and a high-voltage transformer are arranged in a back portion of a heating cooker main body.

### SUMMARY OF THE INVENTION

In the heating cooker of JP 2010-181112 A, a depth dimension of the back portion of the heating cooker main body is shortened by combining an arrangement position and orientation of the high-voltage transformer and the cooling fan. However, in a case where the depth dimension of the back portion of the heating cooker main body is further shortened, there is a possibility that a partition wall (back plate of a heating chamber) with respect to the back portion of the heating cooker main body interferes with a part of the electric component. That is, it is not easy to shorten the depth dimension of the back portion of the heating cooker main body.

In view of the above problem, an object of the present disclosure is to provide a heating cooker in which a depth dimension of a back portion of a heating cooker main body can be shortened.

According to one aspect of the present invention, a heating cooker includes a heating and cooking chamber, a housing, and an electric component. The heating and cooking chamber heats an object to be heated. The housing accommodates the heating and cooking chamber. The electric component is arranged between the heating and cooking chamber and the housing. The heating and cooking chamber has a vertical wall that intersects a horizontal direction. The housing has a vertical outer wall facing the vertical wall. The electric component includes a main body portion and a projecting portion. The main body portion is arranged between the vertical outer wall and the vertical wall. The projecting portion projects from the main body portion in a first direction from the vertical outer wall toward the vertical wall. At least a part of the projecting portion is located further in the first direction than an end portion in a second direction opposite to the first direction of the heating and cooking chamber.

According to the heating cooker of the present disclosure, a depth dimension of a back portion of the heating cooker main body can be shortened.

### BRIEF DESCRIPTION OF THE DRAWINGS

FIG. 1 is a perspective view of a heating cooker according to an embodiment of the present disclosure;

FIG. 2 is a perspective view of the heating cooker according to the present embodiment as viewed from a direction different from that of FIG. 1;

FIG. 3 is a view illustrating a left side surface of the heating cooker according to the present embodiment;

FIG. 4 is a perspective view illustrating the heating cooker in a state where a housing is removed according to the present embodiment;

FIG. 5 is a perspective view illustrating the heating cooker in a state in which the housing according to the present embodiment is removed as viewed from a direction different from that in FIG. 4;

FIG. 6 is a view illustrating a left side surface of the heating cooker in a state where the housing is partially removed according to the present embodiment;

FIG. 7 is a side view illustrating an arrangement mode of a high-voltage transformer;

FIG. 8 is an enlarged view of a region VIII in FIG. 7;

FIG. 9 is an enlarged view of a region IX in FIG. 7;

FIG. 10 is a view illustrating an installation procedure of the high-voltage transformer;

FIG. 11 is a side view illustrating an arrangement mode of the high-voltage transformer according to a variation;

FIG. 12 is an enlarged view of a region XII in FIG. 11; and

FIG. 13 is a side view illustrating an arrangement mode of the high-voltage transformer according to another variation.

### DETAILED DESCRIPTION

Hereinafter, with reference to the drawings, an embodiment of a heating cooker according to the present disclosure will be described. Note that, in the drawings, the same or corresponding portions are denoted by the same reference numerals, and description of such portions will not be repeated.

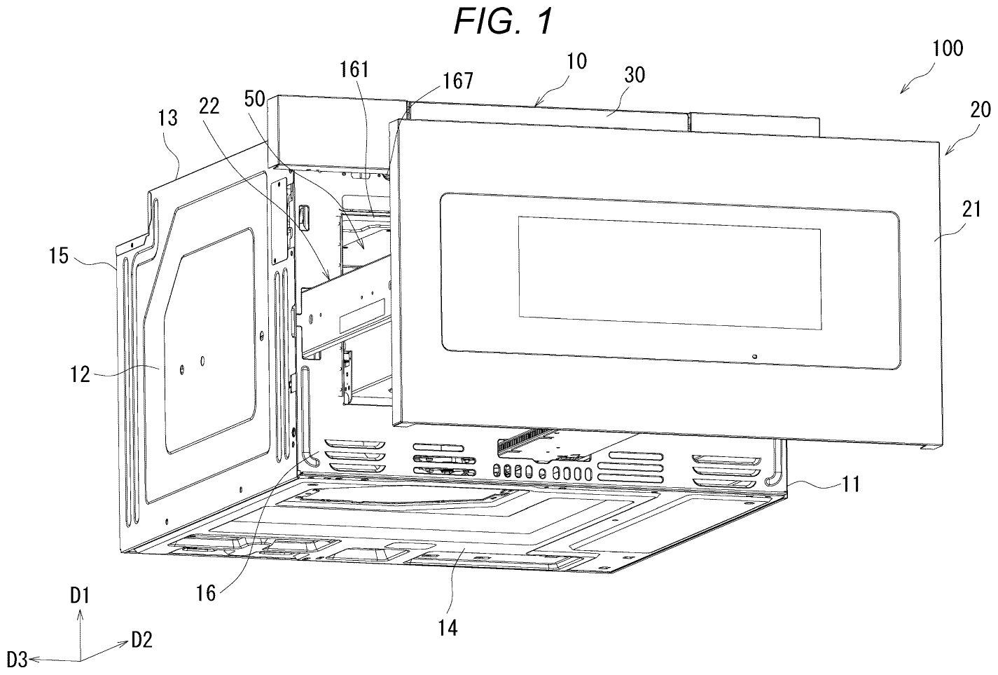

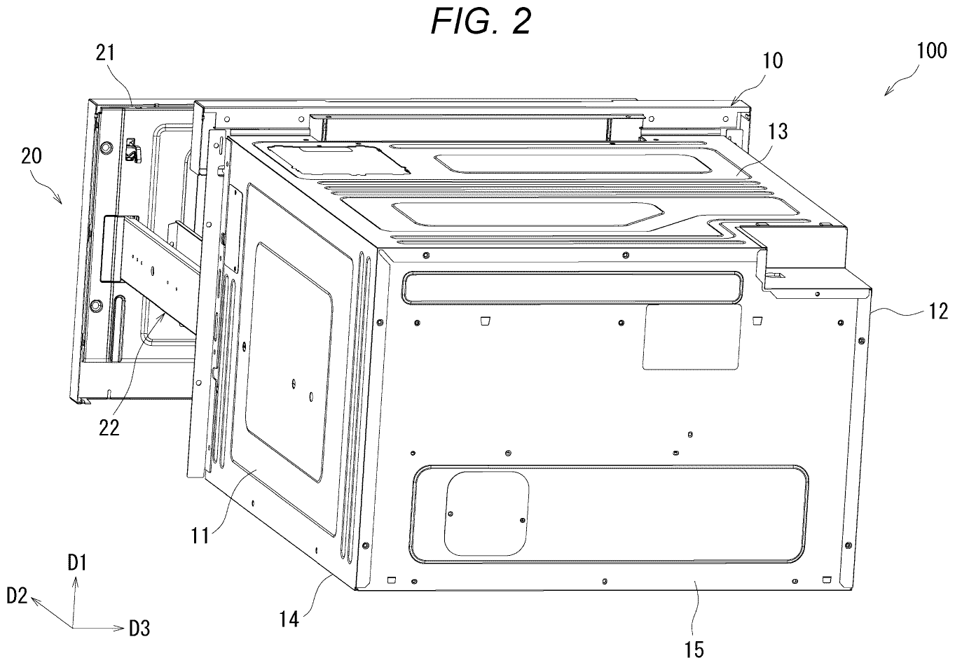

With reference to FIGS. 1 and 2, a heating cooker 100 according to the present embodiment will be described. FIGS. 1 and 2 are perspective views of the heating cooker 100 according to an embodiment of the present disclosure. To be specific, FIG. 1 illustrates the external appearance of the heating cooker 100 when viewed diagonally from the lower left front. FIG. 2 illustrates the external appearance of the heating cooker 100 when viewed diagonally from the upper right rear. As illustrated in FIGS. 1 and 2, the heating cooker 100 is a drawer-type heating cooker. The heating cooker 100 heats and cooks an object to be heated. The object to be heated is, for example, a food item. The heating cooker 100 includes a housing 10, a drawer body 20, and an operation panel 30.

The operation panel 30 is a substantially rectangular plate-shaped member. The operation panel 30 receives operation from the user. The operation includes, for example, a cooking method of heating and cooking an object to be heated. Specifically, the operation panel 30 includes a display unit and a plurality of buttons. The display unit displays various types of information. Specifically, the display unit includes a liquid crystal panel.

In the present embodiment, a side on which the operation panel 30 is arranged of the heating cooker 100 is defined as a front side of the heating cooker 100, and a side (back surface side) opposite to the front side is defined as a rear side of the heating cooker 100. Further, when the heating cooker 100 is viewed from the front side, a right side is defined as a right side of the heating cooker 100, and a side opposite to the right side is defined as a left side of the heating cooker 100. Further, in a direction orthogonal to a front-rear direction and a left-right direction of the heating cooker 100, a side on which the operation panel 30 is arranged is defined as an upper side of the heating cooker 100, and a side (bottom side) opposite to the upper side is defined as a lower side of the heating cooker 100. Note that, these directions are not intended to limit a direction at the time of use of the heating cooker 100 of the present disclosure. In the present embodiment, a first direction D1 may be referred to as an upper direction, a second direction D2 may be referred to as a front direction, and a third direction D3 may be referred to as a left direction.

The housing 10 is a box-shaped member. Specifically, the housing 10 has a right outer wall 11, a left outer wall 12, an upper outer wall 13, a lower outer wall 14, a rear outer wall 15, and a front wall 16. The rear outer wall 15 intersects the second direction D2. The right outer wall 11 and the left outer wall 12 face each other in the third direction D3. The upper outer wall 13 and the lower outer wall 14 face each other in the first direction D1. The lower outer wall 14 is connected to the right outer wall 11, the left outer wall 12, and the rear outer wall 15. The housing 10 accommodates a heating and cooking chamber 50 to be described below. The rear outer wall 15 corresponds to, for example, “vertical outer wall”. Note that the vertical outer wall is not limited to the rear outer wall 15. The vertical outer wall may be the right outer wall 11 or the left outer wall 12.

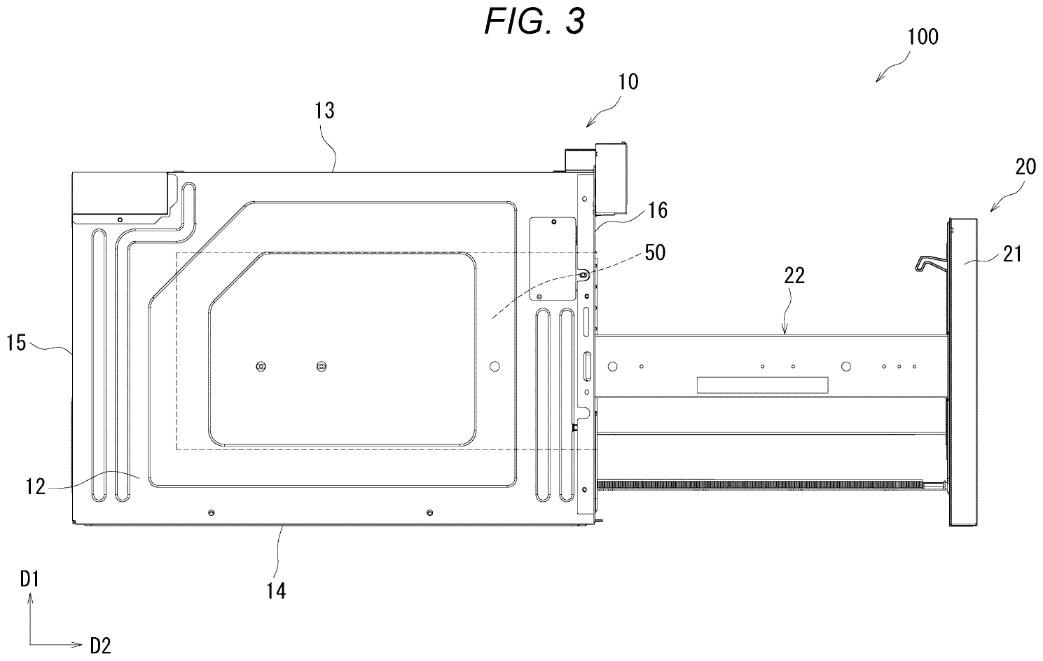

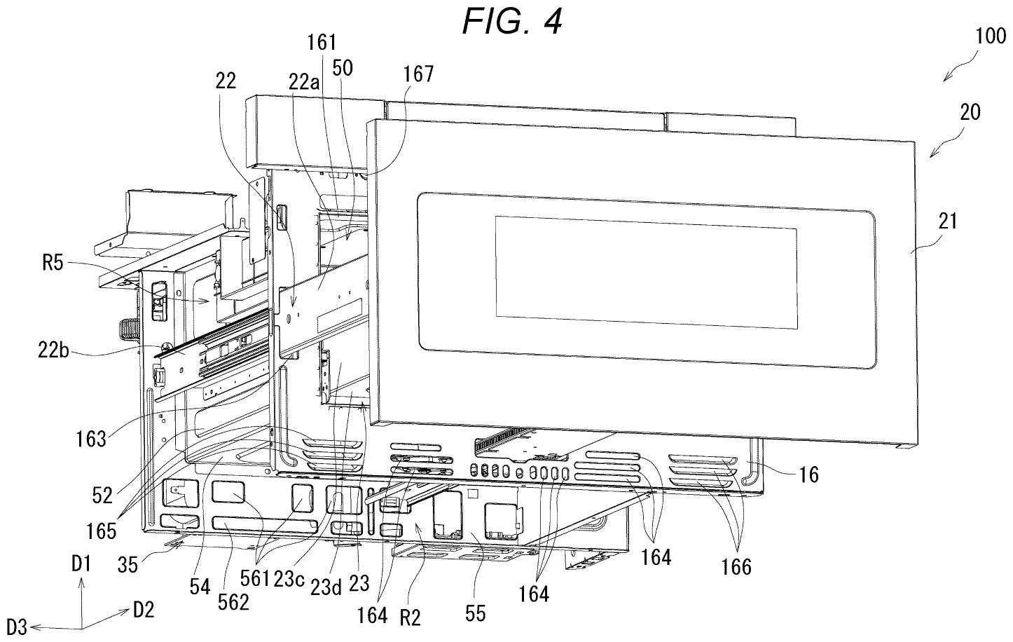

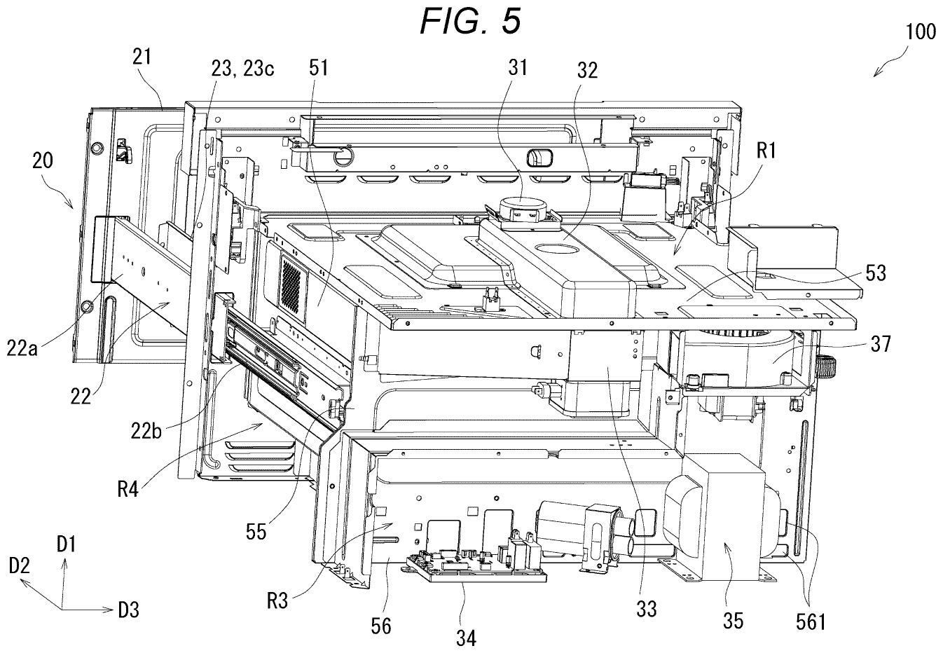

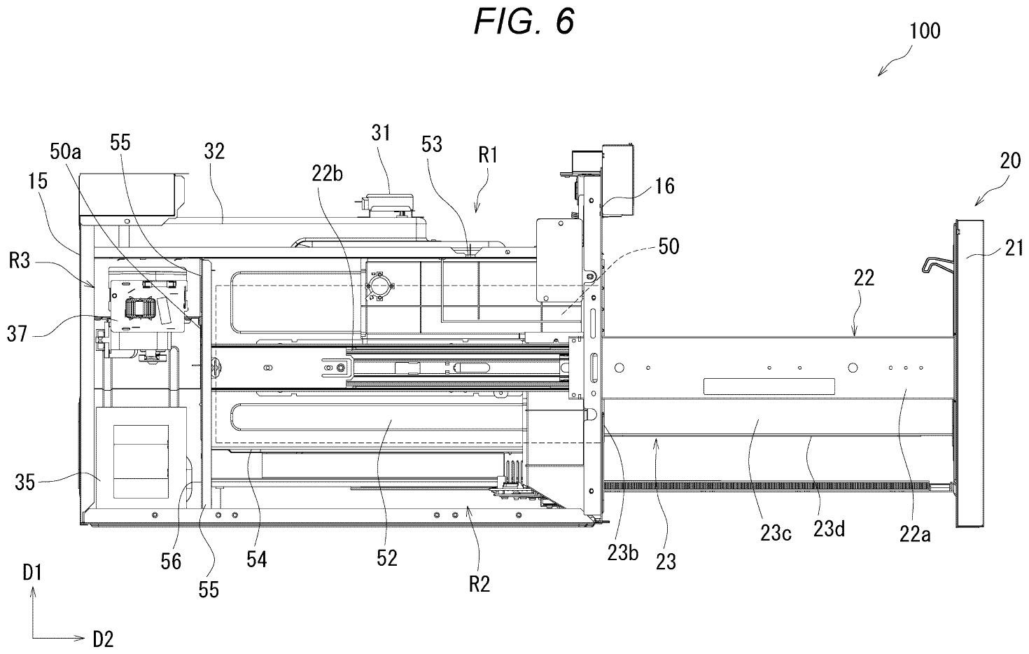

Next, the heating and cooking chamber 50 will be described with reference to FIGS. 3 to 6. FIG. 3 is a view illustrating a left side surface of the heating cooker 100 according to the present embodiment. FIGS. 4 and 5 are perspective views illustrating the heating cooker 100 in a state where the housing 10 is removed according to the present embodiment. To be specific, FIG. 4 illustrates the external appearance of the heating cooker 100 when viewed diagonally from the lower left front. FIG. 5 illustrates the external appearance of the heating cooker 100 when viewed diagonally from the upper right rear. FIG. 6 is a view illustrating a left side surface of the heating cooker 100 in a state where the housing 10 is partially removed according to the present embodiment.

The heating and cooking chamber 50 heats an object to be heated. As illustrated in FIGS. 1 and 3, the heating and cooking chamber 50 is accommodated in the housing 10. The heating and cooking chamber 50 has, for example, a substantially rectangular parallelepiped shape. Specifically, as illustrated in FIGS. 4 to 6, the heating and cooking chamber 50 has a right wall 51, a left wall 52, an upper wall 53, a lower wall 54, and a rear wall 55. The rear wall 55 intersects the second direction D2. The right wall 51 and the left wall 52 face each other in the third direction D3. The rear wall 55 corresponds to, for example, “vertical wall”. Note that the vertical wall is not limited to the rear wall 55. The vertical wall may be the right wall 51 or the left wall 52. The upper wall 53 and the lower wall 54 face each other in the first direction D1. A material of each of the right wall 51, the left wall 52, the upper wall 53, the lower wall 54, and the rear wall 55 is, for example, stainless steel. Note that the material of each wall is not limited to stainless steel. As the material of each wall, any metal having at least predetermined heat resistance and reflectance characteristics may be used.

A front end of the right wall 51, the left wall 52, the upper wall 53, and the lower wall 54 is connected to a rear surface of the front wall 16. A rear end of the right wall 51, the left wall 52, and the lower wall 54 is connected to a front surface of the rear wall 55. An upper end portion of the rear wall 55 is connected to a lower surface of the upper wall 53. The lower wall 54 is separated from and faces the lower outer wall 14 in a vertical direction.

As illustrated in FIGS. 1 and 4, the front wall 16 includes an opening 161, a suction port 164, a first blow-out port 165, a second blow-out port 166, and a third blow-out port 167.

The opening 161 is formed in a substantially rectangular shape. An object to be heated passes through the opening 161. The opening 161 is located further on the inner side than a connection portion between a front end of the right wall 51, the left wall 52, the upper wall 53, and the lower wall 54 and the front wall 16.

Air is sucked between the housing 10 and the heating and cooking chamber 50 from the outside of the housing 10 through the suction port 164. For example, a plurality of the suction ports 164 are provided. A plurality of the suction ports 164 are arranged at a lower position than the opening 161.

Air sucked into a space between the housing 10 and the heating and cooking chamber 50 from the suction port 164 is blown out to the outside through first blow-out port 165, the second blow-out port 166, and the third blow-out port 167. A plurality of the first blow-out ports 165, a plurality of the second blow-out ports 166, and a plurality of the third blow-out ports 167 are provided. The first blow-out port 165 is arranged on the left side of the suction port 164, and the second blow-out port 166 is arranged on the right side of the suction port 164. A plurality of the third blow-out ports 167 are arranged at an upper position than the opening 161.

As illustrated in FIGS. 4 to 6, the rear wall 55 constitutes a rear surface of the heating and cooking chamber 50. In other words, the rear wall 55 constitutes an end portion 50a in a direction opposite to the second direction D2 of the heating and cooking chamber 50. The rear wall 55 intersects a horizontal direction. Specifically, the rear wall 55 is orthogonal to the second direction D2 and faces the rear outer wall 15. The rear wall 55 is connected to the right outer wall 11 and the left outer wall 12. The rear wall 55 is separated from the upper outer wall 13 in the vertical direction. Note that the second direction D2 corresponds to, for example, “first direction”, and a direction opposite to the second direction D2 corresponds to, for example, “second direction”. The rear wall 55 has an extension portion 56.

The extension portion 56 extends from the lower wall 54 to the lower outer wall 14. Left and right end portions of the extension portion 56 are connected to the right outer wall 11 and the left outer wall 12. A lower end portion of the extension portion 56 is connected to the lower outer wall 14. The extension portion 56 has a ventilation opening 561 through which air passes. Air flowing in through the suction port 164 passes through the ventilation opening 561 to the rear side of the rear wall 55. For example, a plurality of the ventilation openings 561 are provided.

Next, the drawer body 20 will be described with reference to FIGS. 1 to 6. The drawer body 20 can be pulled out from the heating and cooking chamber 50. The drawer body 20 opens the opening 161 by movement in the second direction D2, and closes the opening 161 by movement in a direction opposite to the second direction D2. As illustrated in FIGS. 1 to 6, the drawer body 20 includes a door 21, a slide portion 22, and a placement portion 23.

The door 21 is configured to be able to open and close the opening 161. The suction port 164 and each blow-out port are open also in a state where the door 21 closes the opening 161.

As illustrated in FIGS. 4 to 6, the slide portion 22 includes a movable rail 22a and a fixed rail 22b. The slide portion 22 is a telescopic slide mechanism in which the movable rail 22a is slidable with respect to the fixed rail 22b.

On the placement portion 23, an object to be heated is placed. The placement portion 23 includes a rear wall portion 23b, left and right side wall portions 23c, and a bottom wall portion 23d. Front end portions of the left and right side wall portions 23c are connected to a rear surface of the door 21, and rear end portions of the left and right side wall portions 23c are connected to a front surface of the rear wall portion 23b. Lower end portions of the left and right side wall portions 23c and the rear wall portion 23b are connected to the bottom wall portion 23d. Furthermore, the placement portion 23 is connected to the movable rail 22a.

As illustrated in FIGS. 4 to 6, the heating cooker 100 further includes a first space R1, a second space R2, a third space R3, a fourth space R4, and a fifth space R5. The second space R2 is arranged between the lower outer wall 14 and the lower wall 54. The fourth space R4 is arranged between the right outer wall 11 and the right wall 51. The fifth space R5 is arranged between the left outer wall 12 and the left wall 52.

As illustrated in FIGS. 5 and 6, the first space R1 is positioned between the upper outer wall 13 and the upper wall 53. In the first space R1, a motor 31 and a waveguide 32 are arranged. The motor 31 rotates an antenna of a magnetron 33 that is a microwave generation device. The waveguide 32 propagates microwaves generated by the magnetron 33. The heating cooker 100 executes a microwave heating mode by operation of the magnetron 33.

The third space R3 is formed between the rear outer wall 15 and the rear wall 55. For example, the magnetron 33, a control board 34, a high-voltage transformer 35, a high-voltage capacitor 36, and a cooling fan 37 are arranged in the third space R3. The control board 34, the high-voltage transformer 35, and the high-voltage capacitor 36 are placed on an upper portion of the lower outer wall 14 along the third direction D3. The high-voltage transformer 35 corresponds to, for example, “electric component”.

The cooling fan 37 is arranged above the high-voltage transformer 35 adjacent to the left outer wall 12. The cooling fan 37 sucks air from the suction port 164 into the second space R2. Air sucked into the second space R2 flows into the third space R3 through the ventilation opening 561. Air flowing into the third space R3 cools electric components such as the high-voltage transformer 35, then is sent to the first space R1, and is blown out to the outside of the housing 10 through the blow-out port 165.

Next, the drawer body 20 will be described with reference to FIGS. 1 to 6. The drawer body 20 can be pulled out from the heating and cooking chamber 50. The drawer body 20 opens the opening 161 by movement in the second direction D2, and closes the opening 161 by movement in a direction opposite to the second direction D2. As illustrated in FIGS. 1 to 6, the drawer body 20 includes the door 21, the slide portion 22, and the placement portion 23.

As illustrated in FIGS. 4 to 6, the slide portion 22 includes the movable rail 22a and the fixed rail 22b. The slide portion 22 is a telescopic slide mechanism in which the movable rail 22a is slidable with respect to the fixed rail 22b.

On the placement portion 23, an object to be heated is placed. The placement portion 23 includes the rear wall portion 23b, the left and right side wall portions 23c, and the bottom wall portion 23d. Front end portions of the left and right side wall portions 23c are connected to a rear surface of the door 21, and rear end portions of the left and right side wall portions 23c are connected to a front surface of the rear wall portion 23b. Lower end portions of the left and right side wall portions 23c and the rear wall portion 23b are connected to the bottom wall portion 23d. Furthermore, the placement portion 23 is connected to the movable rail 22a.

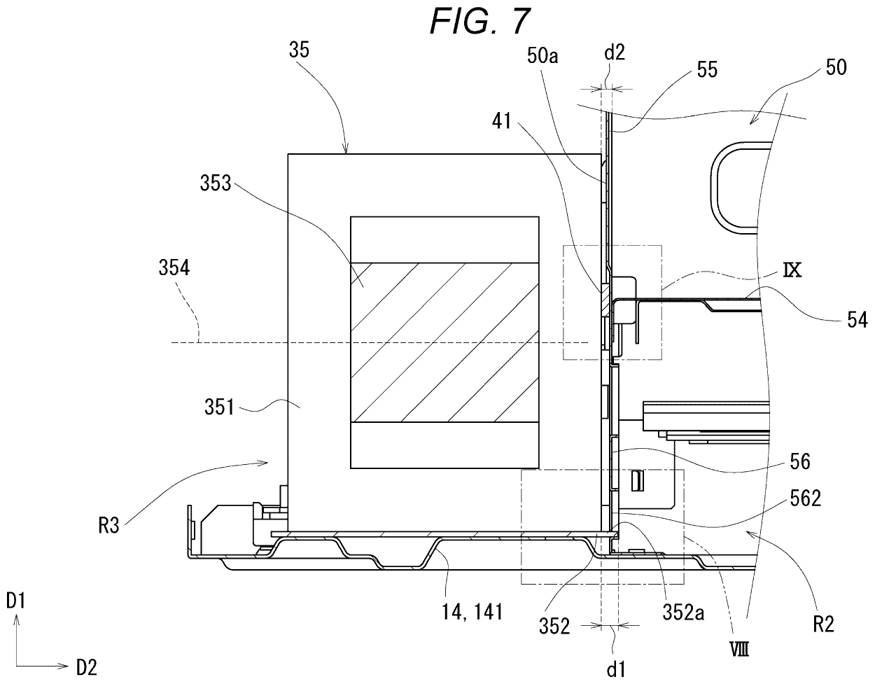

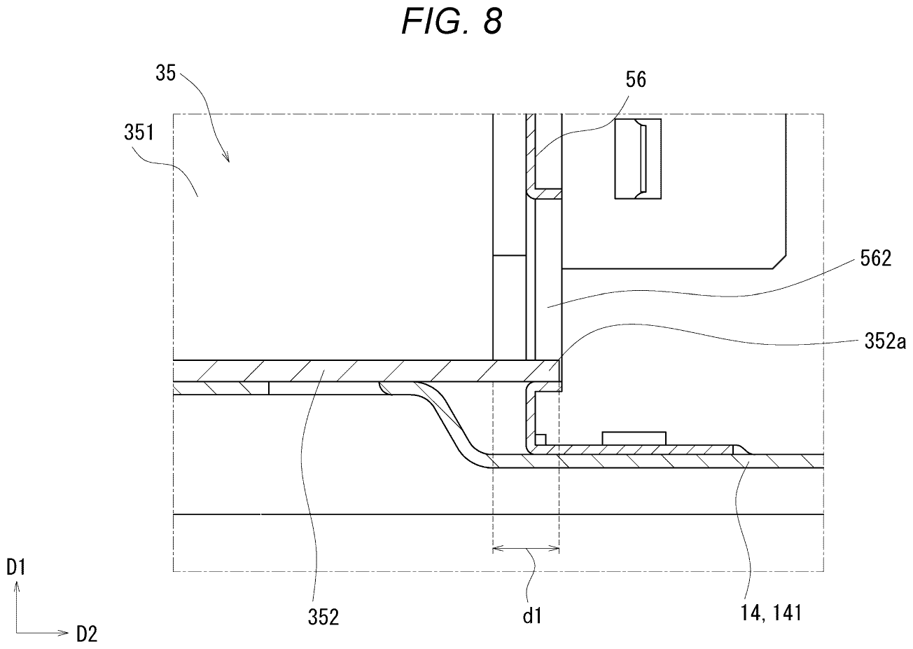

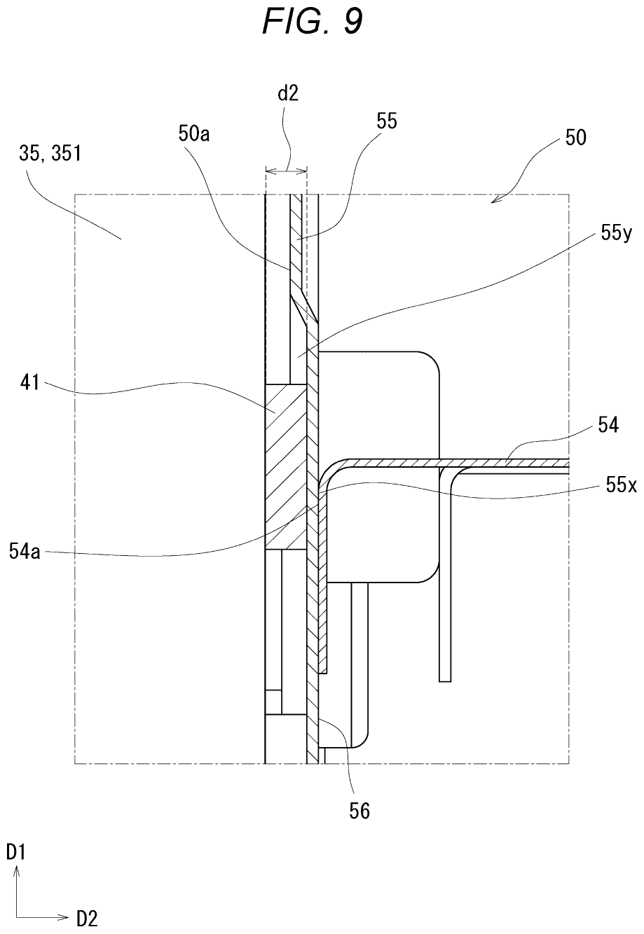

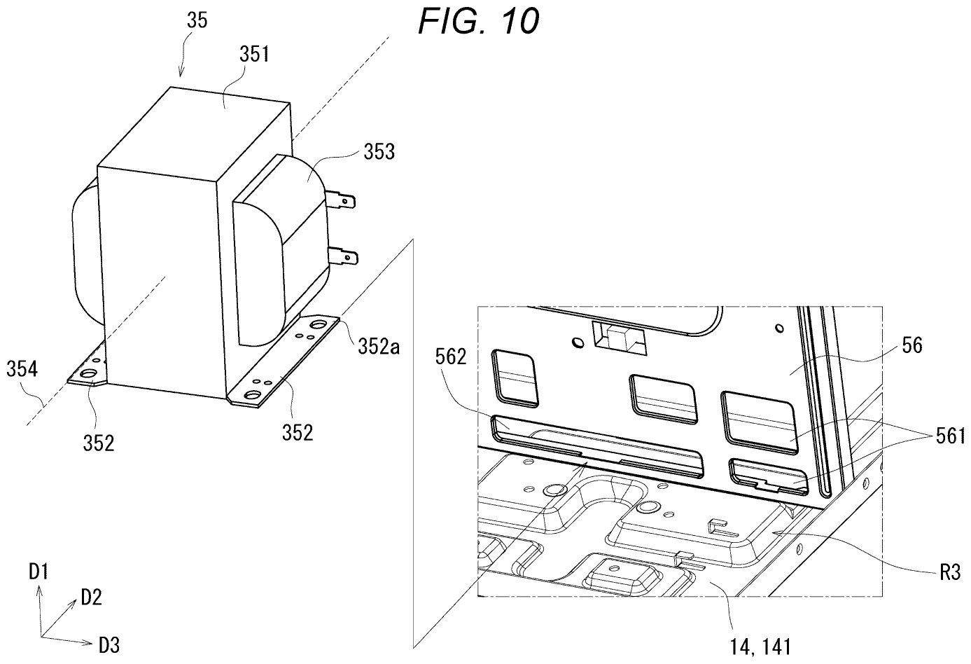

The heating cooker 100 will be further described with reference to FIGS. 7 to 10. FIG. 7 is a side view illustrating an arrangement mode of the high-voltage transformer 35. FIG. 8 is an enlarged view of a region VIII in FIG. 7. FIG. 9 is an enlarged view of a region IX in FIG. 7. FIG. 10 is a view illustrating an arrangement mode of the high-voltage transformer 35.

As illustrated in FIG. 6, the high-voltage transformer 35 is fixed between the rear wall 55 and the rear outer wall 15. In other words, the high-voltage transformer 35 is arranged between the heating and cooking chamber 50 and the housing 10. As illustrated in FIG. 7, the high-voltage transformer 35 includes a main body portion 351 and a projecting portion 352.

The main body portion 351 has, for example, a rectangular parallelepiped shape. The main body portion 351 has an iron core (not illustrated) extending along the second direction D2 in a central portion. Coils (a primary coil and a secondary coil) 353 are wound around the iron core. The main body portion 351 is arranged between the rear wall 55 and the rear outer wall 15. In the present embodiment, since the coil 353 projects in the left-right direction in the main body portion 351, length in the left-right direction of the main body portion 351 is set to be longer than length in the front-rear direction of the main body portion 351. The coil 353 is wound around a winding shaft 354.

The projecting portion 352 is fixed to the lower outer wall 14 by a fixing member such as a screw, for example. As the projecting portion 352 is fixed to the lower outer wall 14, the main body portion 351 is positioned on the lower outer wall 14. As illustrated in FIG. 10, for example, a pair of the projecting portions 352 on the left and right sides are provided at a lower end portion of the main body portion 351. The projecting portion 352 on the left side projects in the third direction D3 from a left lower end portion of the main body portion 351. The projecting portion 352 on the right side projects in a direction opposite to the third direction D3 from a right lower end portion of the main body portion 351. Further, the projecting portion 352 projects in the second direction D2 from the main body portion 351. As illustrated in FIGS. 7, 8, and 10, the projecting portion 352 has a front projecting portion 352a. At least a part of a pair of the projecting portions 352 is fixed to the lower outer wall 14 by a fixing member. For example, an end portion in the second direction D2 is inserted into an opening portion, and an end portion in a direction opposite to the second direction D2 is fixed to the lower outer wall 14 by a fixing member. Further, for example, an end portion in the second direction D2 and an end portion in a direction opposite to the second direction D2 are fixed to the lower outer wall 14 by a fixing member.

The front projecting portion 352a is located at an end portion in the second direction D2 of the projecting portion 352. As illustrated in FIGS. 7 and 8, the front projecting portion 352a is located in front of the rear wall 55. That is, a part of the projecting portion 352 is located further in the second direction D2 than the end portion 50a in a direction opposite to the second direction D2 of the heating and cooking chamber 50. Accordingly, a separation distance in the second direction D2 between the rear wall 55 of the heating and cooking chamber 50 and the high-voltage transformer 35 decreases. Specifically, since at least a part of the projecting portion 352 is located in front of the end portion 50a of the heating and cooking chamber 50, the main body portion 351 of the high-voltage transformer 35 and the rear wall 55 can be brought close to each other. As a result, the rear wall 55 and the rear outer wall 15 can be brought close to each other. That is, even an electric component whose entire outer shape does not fit between the rear wall 55 and the rear outer wall 15 in terms of shape can be arranged between the rear wall 55 and the rear outer wall 15 as long as the main body portion fits between the rear wall 55 and the rear outer wall 15.

As illustrated in FIGS. 7, 8, and 10, the lower outer wall 14 has a lower outer wall main body 141. The lower outer wall main body 141 supports the high-voltage transformer 35. That is, the high-voltage transformer 35 is supported by the lower outer wall 14. Since an electric component is supported by the lower outer wall 14, a heavy electric component can be arranged between the rear wall 55 and the rear outer wall 15.

A vertical wall intersects the horizontal direction. Specifically, the vertical wall is the rear wall 55 facing the opening 161 (see FIG. 4). Since at least a part of the projecting portion 352 is located further in the second direction D2 than the rear wall 55, a distance between the rear wall 55 and the rear outer wall 15 can be shortened. Accordingly, a dimension in the depth direction of the heating cooker 100 is shortened.

The extension portion 56 has a first opening 562. The first opening 562 is arranged on the left side and a lower end portion of the rear wall 55. The first opening 562 has a substantially rectangular shape. Length in the vertical direction of the first opening 562 is longer than length in the vertical direction of the projecting portion 352. Length in the left-right direction of the first opening 562 is longer than length from a left end portion of the projecting portion 352 on the left side to a right end portion of the projecting portion 352 on the right side.

As illustrated in FIG. 10, when the high-voltage transformer 35 is arranged on the lower outer wall main body 141, the projecting portion 352 is inserted in the second direction D2 into the first opening 562. Specifically, the front projecting portion 352a is inserted into the first opening 562. By the above, even in the heating and cooking chamber 50 having the extension portion 56, with a simple configuration, a part of the projecting portion 352 is arranged further in second direction D2 than the end portion 50a of the heating and cooking chamber 50. After the front projecting portion 352a is inserted into the first opening 562, the projecting portion 352 is fixed to the lower outer wall main body 141. A bent portion that bends in the second direction D2 is provided around the first opening 562. The front projecting portion 352a is placed on the bent portion of the first opening 562. A front end portion of the bent portion is located further on the second direction D2 side than a front end portion of the front projecting portion 352a.

As illustrated in FIG. 4, the cooling fan 37 sucks air into the second space R2 from the suction port 164. The air sucked into the second space R2 flows not only to the ventilation opening 561 but also to the lower side of a main body back portion of the third space R3 through the first opening 562. The air that flows into the third space R3 cools an electric component and then is sucked into the cooling fan 37. The cooling fan 37 cools the magnetron 33 with blown air. Air that cools the magnetron 33 is discharged to the outside through a first path, a second path, and a third path. The first path is directed toward the first blow-out port 165 via the heating and cooking chamber 50. A duct member through which air can flow is provided between the heating and cooking chamber 50 and the first blow-out port 165. The second path is directed toward the second blow-out port 166 via the fourth space R4. The third path is directed toward the third blow-out port 167 via the first space R1 on the top surface side. Further, an opening through which the projecting portion 352 is inserted and an opening through which air for cooling passes are shared.

As illustrated in FIGS. 7 and 9, the heating cooker 100 includes an elastic member 41 having elasticity. The elastic member 41 has a vibration damping function. The elastic member 41 can be selected from materials having a large damping ratio, such as anti-vibration rubber and urethane. The elastic member 41 is arranged between a front surface of the main body portion 351 and a connection region 55x of the rear wall 55. Length d2 in the second direction D2 of the elastic member 41 is shorter than length d1 in the second direction D2 of the front projecting portion 352a. The high-voltage transformer 35 can be pressed using the elastic member 41 having a shorter length in the second direction D2 than the front projecting portion 352a.

The rear wall 55 has a recessed portion 55y in a direction opposite to the second direction D2. The elastic member 41 is arranged in the recessed portion 55y. Depth length in the second direction D2 of the recessed portion 55y is shorter than the length d2 in the second direction D2 of the elastic member 41. A connection region 55x is formed on a surface in the second direction D2 of the recessed portion 55y.

As illustrated in FIG. 9, the connection region 55x is a region of the rear wall 55 to which the lower wall 54 is connected. An end portion 54a of the lower wall 54 in a direction opposite to the second direction D2 is fixed to the connection region 55x of the rear wall 55. The end portion 54a of the lower wall 54 is fixed to the connection region 55x by welding, for example. The elastic member 41 contacts a front surface of the high-voltage transformer 35 and the rear wall 55. The elastic member 41 preferably contacts at least a part of the connection region 55x in the rear wall 55. The elastic member 41 is in contact with a front surface of the high-voltage transformer 35 and the connection region 55x on the rear wall 55 between the high-voltage transformer 35 and the connection region 55x, and thus the lower wall 54 supports movement toward a front direction of the elastic member 41. As a result, the high-voltage transformer 35 can be pressed by a portion having high strength via the elastic member 41.

The elastic member 41 includes a damping member that damps vibration of an electric component. The electric component includes the high-voltage transformer 35. By the above, the elastic member 41 can damp vibration of the high-voltage transformer 35.

As illustrated in FIGS. 7 and 10, the high-voltage transformer 35 includes the winding shaft 354 of the coil 353. In the high-voltage transformer 35, the winding shaft 354 is arranged along the second direction D2. Since the winding shaft 354 is arranged along the second direction D2, a magnetic field acting along the second direction D2 is generated. In particular, in a case where a separation distance between the rear wall 55 of the heating and cooking chamber 50 and the high-voltage transformer 35 is shortened, influence of a magnetic field on the rear wall 55 increases. Even if influence of the magnetic field is large, vibration of the rear wall 55 caused by the magnetic field can be suppressed by the elastic member 41.

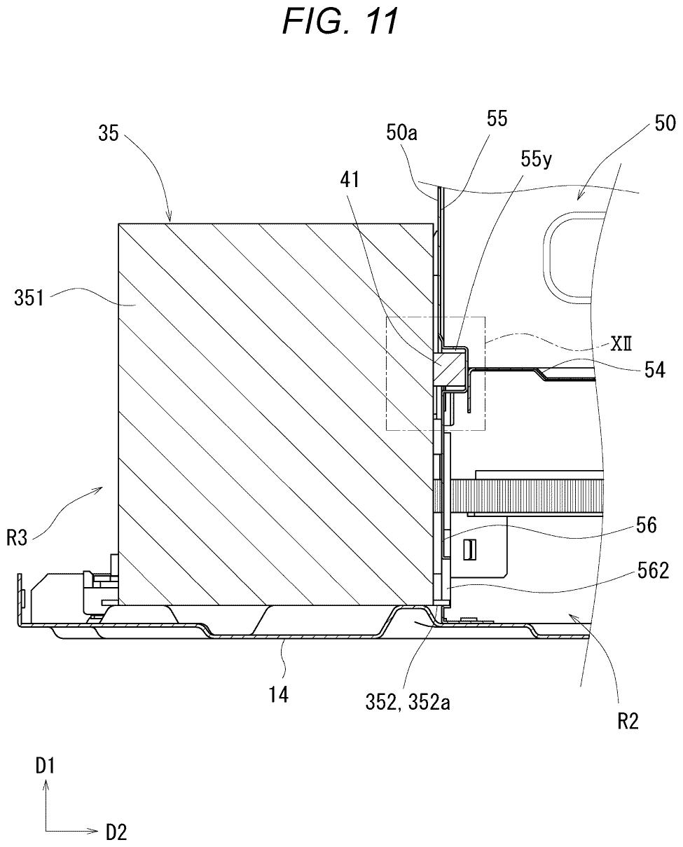

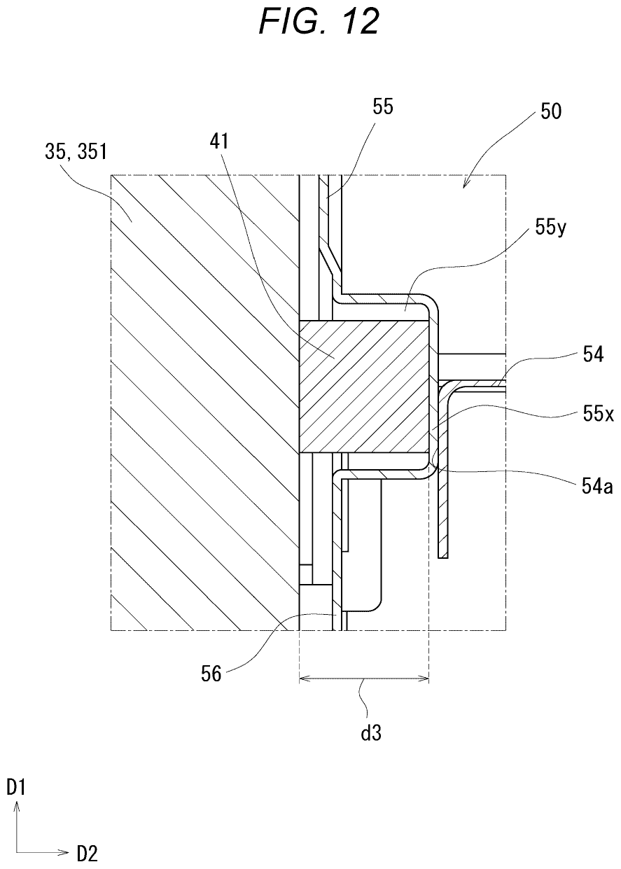

A variation of an arrangement mode of the high-voltage transformer 35 will be described with reference to FIGS. 11 and 12. FIG. 11 is a side view illustrating an arrangement mode of the high-voltage transformer 35 according to the variation. FIG. 12 is an enlarged view of a region XII in FIG. 11. The heating cooker 100 has a recessed portion 55y.

As illustrated in FIGS. 11 and 12, the recessed portion 55y recessed in the second direction D2 is provided in the connection region 55x of the rear wall 55. A part of the elastic member 41 is arranged in the recessed portion 55y. The elastic member 41 is arranged between a front surface of the main body portion 351 and the connection region 55x of the rear wall 55.

Length d3 in the second direction D2 of the elastic member 41 is longer than the length d1 in the second direction D2 of the front projecting portion 352a. Length in the second direction D2 of the recessed portion 55y is shorter than the length d3 in the second direction D2 of the elastic member 41. The connection region 55x is arranged on a surface in the second direction D2 of the recessed portion 55y. As described above, even in a case where the elastic member 41 having the length d3 in the second direction D2 longer than the length d1 in the second direction D2 of the front projecting portion 352a is used, it is possible to press an electric component at a portion having high strength via the elastic member 41.

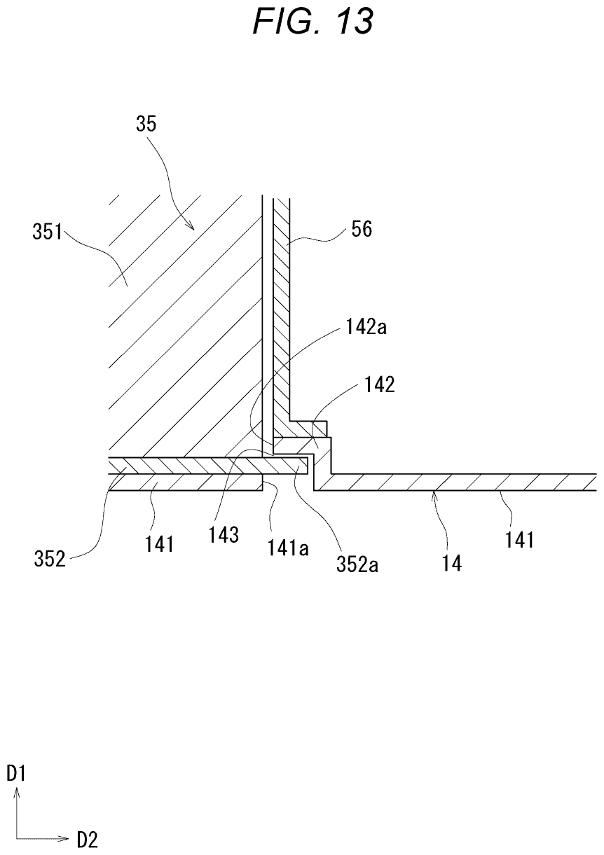

Another variation of an arrangement mode of the high-voltage transformer 35 will be described with reference to FIG. 13. FIG. 13 is a side view illustrating an arrangement mode of the high-voltage transformer 35 according to another variation. As illustrated in FIG. 13, the lower outer wall 14 includes the lower outer wall main body 141, a stepped portion 142, and a second opening 143.

The lower outer wall main body 141 supports the high-voltage transformer 35. The projecting portion 352 is mounted on the lower outer wall main body 141.

The stepped portion 142 projects from the lower outer wall main body 141 toward the heating and cooking chamber 50. Specifically, the stepped portion 142 projects in the first direction D1 from the lower outer wall main body 141 so as to be higher than length in the vertical direction of the projecting portion 352. Length in the left-right direction of the stepped portion 142 is longer than length from a left end portion of the projecting portion 352 on the left side to a right end portion of the projecting portion 352 on the right side.

The second opening 143 opens in a direction opposite to the second direction D2. The second opening 143 includes an end portion 142a in a direction opposite to the second direction D2 of the stepped portion 142, and an end portion 141a of the lower outer wall main body 141 corresponding to the end portion 142a of the stepped portion 142. The second opening 143 is formed in, for example, a horizontally long substantially rectangular shape.

The projecting portion 352 is inserted into the second opening 143. Specifically, the projecting portion 352 is inserted from the rear toward the front toward the second opening 143. In other words, the front projecting portion 352a enters the inside of the stepped portion 142. By the above, the projecting portion 352 is inserted into the second opening 143 and hence, the projecting portion 352 is sandwiched between the lower outer wall main body 141 and the stepped portion 142 arranged in the vicinity of the second opening 143, so that movement in the vertical direction of an electric component can be restricted.

The embodiment of the present disclosure is described above with reference to the drawings. However, the present disclosure is not limited to the above embodiment, and can be implemented in various aspects without departing from the gist of the present disclosure (for example, (1) to (4) described below). For easy understanding, the drawings schematically illustrate each constituent element mainly, and thickness, length, the number, and the like of constituent elements illustrated in the drawings are different from actual ones for convenience of preparation of the drawings. Further, materials, shapes, dimensions, and the like of constituent elements illustrated in the above embodiment are merely examples, and are not particularly limited, and various modifications can be made without substantially departing from the effect of the present disclosure.

(1) As described with reference to FIGS. 1 to 13, the electric component is the high-voltage transformer 35 including the main body portion 351 and the projecting portion 352, but the present disclosure is not limited to this. The electric component only needs to have at least the main body portion and the projecting portion, and can be optionally selected from a control board, a high-voltage capacitor, and the like.

(2) As described with reference to FIGS. 1 to 13, the high-voltage transformer 35 (electric component) is arranged between the rear wall 55 and the rear outer wall 15, but the present disclosure is not limited to this. At least a part of the projecting portion 352 may be located further on the inner side than an outer end portion of the heating and cooking chamber 50 in plan view. Therefore, the electric component may be arranged between the right wall 51 and the right outer wall 11, or may be arranged between the left wall 52 and the left outer wall 12.

(3) As described with reference to FIGS. 1 to 12, the first opening 562 is arranged in the extension portion 56, but the present disclosure is not limited to this. A recessed portion projecting toward the heating and cooking chamber 50 may be formed in the extension portion 56, and the projecting portion 352 may be caused to enter the recessed portion.

(4) As described with reference to FIGS. 1 to 13, the heating cooker 100 executes only a microwave heating mode as a heating cooking mode, but the present disclosure is not limited to this. The heating cooker 100 may execute other cooking modes such as a grill heating mode and a hot air circulation heating mode in addition to the microwave heating mode as the heating cooking mode. The grill heating mode is a mode for heating and cooking an object to be heated mainly by exposing the object to be heated to radiant heat. The hot air circulation heating mode is a mode for heating and cooking an object to be heated mainly by circulating hot air in the inside of the heating and cooking chamber 50 to achieve uniform temperature in the heating and cooking chamber 50.

### INDUSTRIAL APPLICABILITY

The present disclosure is useful, for example, in the field of heating cookers.

What is claimed is:

1. A heating cooker comprising:
a heating and cooking chamber configured to heat an object to be heated;
a housing configured to accommodate the heating and cooking chamber; and
an electric component arranged between the heating and cooking chamber and the housing,
wherein the heating and cooking chamber has a vertical wall that intersects a horizontal direction,
the housing has a vertical outer wall facing the vertical wall,
the electric component includes
a main body portion that is arranged between the vertical outer wall and the vertical wall, and
a projecting portion that projects from the main body portion in a first direction from the vertical outer wall toward the vertical wall, and
at least a part of the projecting portion is located further in the first direction than an end portion in a second direction opposite to the first direction of the heating and cooking chamber.

2. The heating cooker according to claim 1,
wherein the heating and cooking chamber has a lower wall that is connected to the vertical wall,
the housing includes a lower outer wall that is connected to the vertical outer wall and faces the lower wall, and
the electric component is supported by the lower outer wall.

3. The heating cooker according to claim 1,
wherein the heating and cooking chamber further has an opening through which an object to be heated passes, and
the vertical wall is a rear wall facing the opening.

4. The heating cooker according to claim 1,
wherein the heating and cooking chamber has a lower wall connected to the vertical wall,
the housing includes a lower outer wall that is connected to the vertical outer wall and faces the lower wall,
the vertical wall includes an extension portion that forms an end portion in the second direction of the heating and cooking chamber and extends from the lower wall to the lower outer wall,
the extension portion has a first opening, and
the projecting portion is inserted into the first opening in the first direction.

5. The heating cooker according to claim 4, further comprising
a cooling fan arranged between the vertical wall and the vertical outer wall,
wherein the housing includes
a suction port through which air is sucked into a space between the housing and the heating and cooking chamber from an outside of the housing, and
a blow-out port through which the air is blown out from a space between the housing and the heating and cooking chamber, and
the cooling fan is configured to cause the air sucked through the suction port to pass through the first opening and send the air to the blow-out port.

6. The heating cooker according to claim 2,
wherein the lower outer wall includes
a lower outer wall main body,
a stepped portion projecting from the lower outer wall main body toward the heating and cooking chamber, and
a second opening that opens in the second direction,
the second opening includes an end portion in the second direction of the stepped portion and an end portion of the lower outer wall main body corresponding to the end portion in the second direction of the stepped portion, and
the projecting portion is inserted into the second opening.

7. The heating cooker according to claim 1, further comprising
an elastic member having elasticity,
wherein the heating and cooking chamber has a lower wall connected to the vertical wall,
the vertical wall has a connection region to which the lower wall is connected,
an end portion in the second direction of the lower wall is fixed to the connection region of the vertical wall, and
the elastic member is in contact with the electric component and the connection region between the electric component and the connection region.

8. The heating cooker according to claim 7,
wherein the connection region of the vertical wall has a recessed portion that is recessed in the first direction, and
the recessed portion is configured to accommodate a part of the elastic member.

9. The heating cooker according to claim 7,
wherein the elastic member includes a damping member configured to damp vibration of the electric component, and
the electric component includes a transformer.

10. The heating cooker according to claim 9,
wherein the transformer includes
a winding shaft, and
a coil wound around the winding shaft, and
the winding shaft is arranged along the first direction.
